(19) United States
(12) Patent Application Publication
(10) Pub. No.: US 2023/0008729 A1
(43) Pub. Date: Jan. 12, 2023

(54) MILLIMETER WAVE RADAR APPARATUS DETERMINING FALL POSTURE

(71) Applicant: WANSHIH ELECTRONIC CO., LTD., New Taipei City (TW)

(72) Inventors: Chun-Chi KO, New Taipei City (TW); Hsin-Yen LEE, New Taipei City (TW)

(21) Appl. No.: 17/372,513

(22) Filed: Jul. 11, 2021

(51) Int. Cl. G08B 21/04; G01S 13/06; G01S 13/89; G01S 13/88

(52) U.S. Cl. CPC G08B 21/043; G01S 13/06; G01S 13/89; G01S 13/886; G08B 21/0469

(57) ABSTRACT

A millimeter wave radar apparatus determining a fall posture is applied to a human body. The millimeter wave radar apparatus includes a microprocessor and a millimeter wave radar. The millimeter wave radar is electrically connected to the microprocessor. The millimeter wave radar is configured to transmit a radar wave to the human body. The millimeter wave radar is configured to receive a reflected radar wave reflected from the human body based on the radar wave. The microprocessor is configured to obtain a point cloud information based on the reflected radar wave. The microprocessor is configured to utilize the point cloud information to determine whether the human body is in the fall posture.

### BACKGROUND

### Technical Field

The present disclosure relates to a millimeter wave radar apparatus, and especially relates to a millimeter wave radar apparatus determining a fall posture.

### Description of Related Art

The fall is one of the most common conditions for human body accidents. Especially for the elderly, the fall is very dangerous, ranging from an injury to bones to severely fatal. Currently, there are some apparatuses which can sense or monitor whether the elderly fall, but these apparatuses are inconvenient wearable apparatuses, or are video cameras which cannot allow the elderly to keep their privacy, and the accuracy of these apparatuses to monitor whether they fall is not high.

### SUMMARY OF THE DISCLOSURE

In order to solve the above-mentioned problems, an object of the present disclosure is to provide a millimeter wave radar apparatus determining a fall posture.

In order to achieve the object of the present disclosure mentioned above, the millimeter wave radar apparatus of the present disclosure is applied to a human body. The millimeter wave radar apparatus includes a microprocessor and a millimeter wave radar. The millimeter wave radar is electrically connected to the microprocessor. Moreover, the millimeter wave radar is configured to transmit a radar wave to the human body. The millimeter wave radar is configured to receive a reflected radar wave reflected from the human body based on the radar wave. The microprocessor is configured to obtain a point cloud information based on the reflected radar wave. The microprocessor is configured to utilize the point cloud information to determine whether the human body is in the fall posture.

Moreover, in an embodiment of the millimeter wave radar apparatus of the present disclosure mentioned above, moreover the microprocessor includes a point cloud capturing unit. The point cloud capturing unit is electrically connected to the millimeter wave radar. Moreover, the point cloud capturing unit is configured to obtain the point cloud information based on the reflected radar wave.

Moreover, in an embodiment of the millimeter wave radar apparatus of the present disclosure mentioned above, moreover the microprocessor further includes a point cloud classification unit. The point cloud classification unit is electrically connected to the point cloud capturing unit. Moreover, the point cloud capturing unit is configured to transmit the point cloud information to the point cloud classification unit. The point cloud classification unit is configured to classify the point cloud information to obtain a point cloud classification information.

Moreover, in an embodiment of the millimeter wave radar apparatus of the present disclosure mentioned above, moreover the microprocessor further includes a point cloud characterization unit. The point cloud characterization unit is electrically connected to the point cloud classification unit. Moreover, the point cloud classification unit is configured to transmit the point cloud classification information to the point cloud characterization unit. The point cloud characterization unit is configured to characterize the point cloud classification information to obtain a point cloud characterization information.

Moreover, in an embodiment of the millimeter wave radar apparatus of the present disclosure mentioned above, moreover the microprocessor further includes a point cloud characteristic extracting unit. The point cloud characteristic extracting unit is electrically connected to the point cloud characterization unit. Moreover, the point cloud characterization unit is configured to transmit the point cloud characterization information to the point cloud characteristic extracting unit. The point cloud characteristic extracting unit is configured to obtain a characteristic information based on the point cloud characterization information.

Moreover, in an embodiment of the millimeter wave radar apparatus of the present disclosure mentioned above, moreover the microprocessor further includes a characteristic comparing unit. The characteristic comparing unit is electrically connected to the point cloud characteristic extracting unit. Moreover, the point cloud characteristic extracting unit is configured to transmit the characteristic information to the characteristic comparing unit.

Moreover, in an embodiment of the millimeter wave radar apparatus of the present disclosure mentioned above, moreover the microprocessor further includes a characteristic database unit. The characteristic database unit is electrically connected to the characteristic comparing unit. Moreover, the characteristic database unit is configured to transmit a fall characteristic information to the characteristic comparing unit. The characteristic comparing unit is configured to compare the characteristic information with the fall characteristic information. If the characteristic information matches the fall characteristic information, the characteristic comparing unit is configured to determine that the human body is in the fall posture.

Moreover, in an embodiment of the millimeter wave radar apparatus of the present disclosure mentioned above, the millimeter wave radar apparatus further includes a warning unit. The warning unit is electrically connected to the characteristic comparing unit. Moreover, if the characteristic comparing unit determines that the human body is in the fall posture, the characteristic comparing unit is configured to inform the warning unit that the human body is in the fall posture. Moreover, the microprocessor further includes a point cloud reliability checking unit. The point cloud reliability checking unit is electrically connected to the point cloud capturing unit. Moreover, the point cloud reliability checking unit is configured to check the point cloud information. If the point cloud information checked by the point cloud reliability checking unit is correct, the point cloud capturing unit is configured to transmit the point cloud information to the point cloud classification unit.

Moreover, in an embodiment of the millimeter wave radar apparatus of the present disclosure mentioned above, moreover the warning unit is an output warning apparatus.

Moreover, in an embodiment of the millimeter wave radar apparatus of the present disclosure mentioned above, moreover the warning unit is configured to transmit a warning signal provided to other apparatuses to use.

The advantage of the present disclosure is to conveniently and accurately determine that the human body is in the fall posture, so as to further warn and provide assistance or rescue.

Please refer to the detailed descriptions and figures of the present disclosure mentioned below for further understanding the technology, method and effect of the present disclosure achieving the predetermined purposes. It believes that the purposes, characteristic and features of the present disclosure can be understood deeply and specifically. However, the figures are only for references and descriptions, but the present disclosure is not limited by the figures.

### BRIEF DESCRIPTION OF THE DRAWINGS

FIG. 1 shows a block diagram of the millimeter wave radar apparatus of the present disclosure.

FIG. 2 shows the human body and an embodiment of the point cloud information of the present disclosure in accordance with the human body.

FIG. 3 shows an application embodiment diagram of the millimeter wave radar apparatus of the present disclosure.

FIG. 4 shows an embodiment of the millimeter wave radar apparatus of the present disclosure determining that the human body changes the posture.

FIG. 5 shows another embodiment of the millimeter wave radar apparatus of the present disclosure determining that the human body changes the posture.

FIG. 6 shows a block diagram of the microprocessor of the present disclosure.

FIG. 7 shows a block diagram of an embodiment of the millimeter wave radar of the present disclosure.

FIG. 8 shows a block diagram of an embodiment of the analog-to-digital circuit of the present disclosure.

FIG. 9 shows a partial block diagram of an embodiment of the millimeter wave receiving circuit of the present disclosure.

FIG. 10 shows another partial block diagram of the embodiment of the millimeter wave receiving circuit of the present disclosure.

FIG. 11 shows a block diagram of an embodiment of the millimeter wave transmitting circuit of the present disclosure.

### DETAILED DESCRIPTION

In the present disclosure, numerous specific details are provided, to provide a thorough understanding of embodiments of the disclosure. Persons of ordinary skill in the art will recognize, however, that the present disclosure can be practiced without one or more of the specific details. In other instances, well-known details are not shown or described to avoid obscuring aspects of the present disclosure. Now please refer to the figures for the explanation of the technical content and the detailed description of the present disclosure:

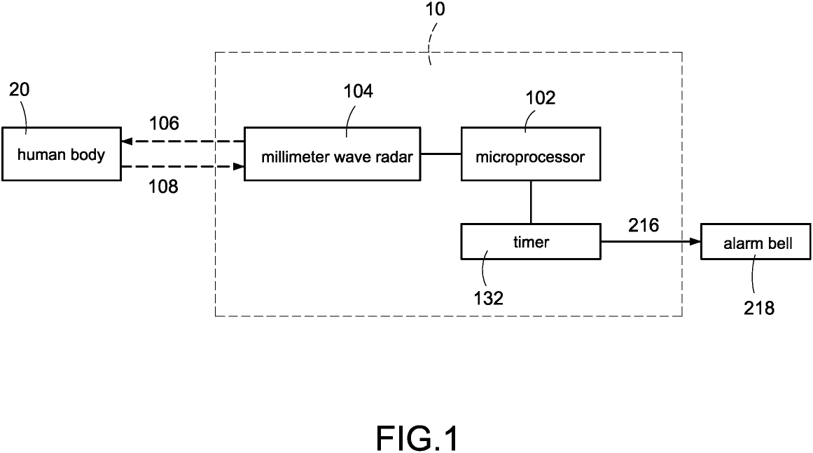

FIG. 1 shows a block diagram of the millimeter wave radar apparatus of the present disclosure. A millimeter wave radar apparatus 10 determining a fall posture of the present disclosure is applied to a human body 20. The millimeter wave radar apparatus 10 includes a microprocessor 102, a millimeter wave radar 104 and a warning unit 132. The microprocessor 102 is electrically connected to the millimeter wave radar 104 and the warning unit 132. The warning unit 132 is, for example but not limited to, a loudspeaker which can generate a warning sound, or a wireless signal transmitter (not shown in FIG. 1) which can inform a wireless signal receiver (not shown in FIG. 1), or an output warning apparatus, or configured to transmit a warning signal 216 which is provided to other apparatuses 218 to use.

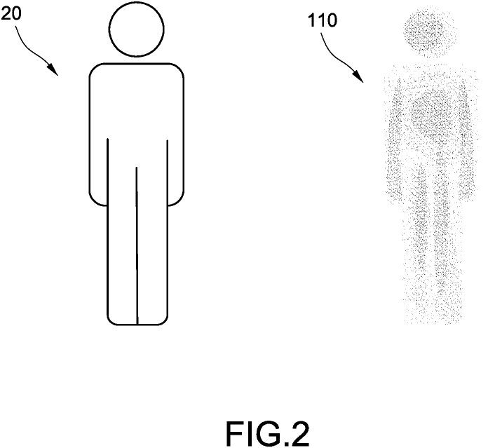

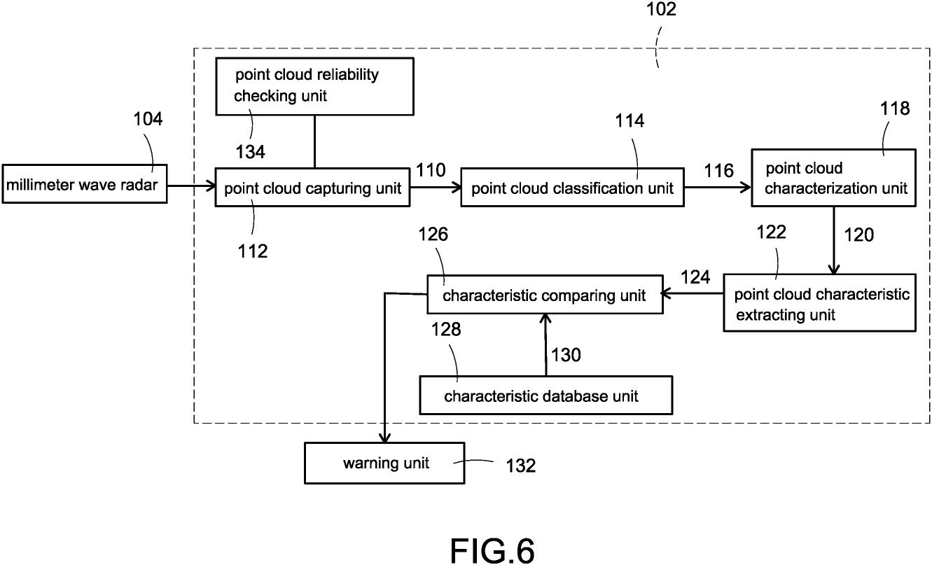

The millimeter wave radar 104 is configured to transmit a radar wave 106 to the human body 20. The millimeter wave radar 104 is configured to receive a reflected radar wave 108 reflected from the human body 20 based on the radar wave 106. The microprocessor 102 is configured to obtain a point cloud information 110 (as shown in FIG. 2 and FIG. 6) based on the reflected radar wave 108. The microprocessor 102 is configured to utilize the point cloud information 110 to determine whether the human body 20 is in the fall posture. FIG. 2 shows the human body and an embodiment of the point cloud information of the present disclosure in accordance with the human body. The point cloud information 110 shown in FIG. 2 is just an embodiment but the present disclosure is not limited by FIG. 2.

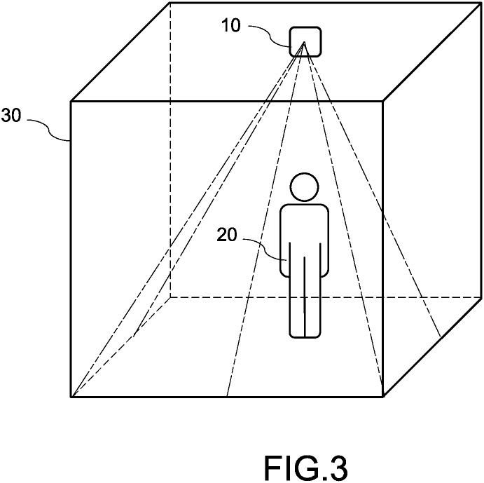

FIG. 3 shows an application embodiment diagram of the millimeter wave radar apparatus of the present disclosure. The millimeter wave radar apparatus 10 of the present disclosure can be arranged in a room 30 to determine whether the human body 20 is in the fall posture. Moreover, the room 30 is, for example but not limited to, an apartment or a shower room. Especially when people take a shower in the shower room, they need privacy, and it is also inconvenient to wear any fall determination apparatuses.

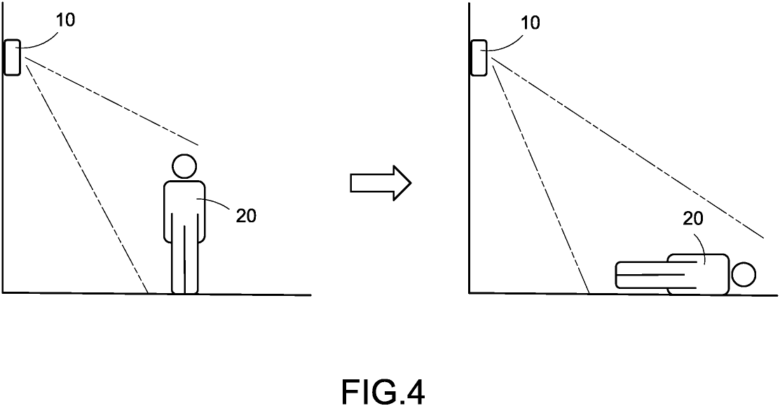

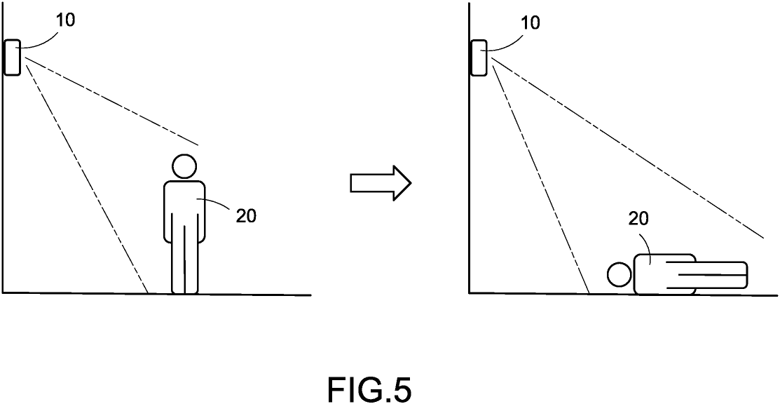

FIG. 4 shows an embodiment of the millimeter wave radar apparatus of the present disclosure determining that the human body changes the posture. The left half of FIG. 4 shows that the human body 20 is in a stand posture. The right half of FIG. 4 shows that the human body 20 changes to be in the fall posture. FIG. 5 shows another embodiment of the millimeter wave radar apparatus of the present disclosure determining that the human body changes the posture. The left half of FIG. 5 shows that the human body 20 is in the stand posture. The right half of FIG. 5 shows that the human body 20 changes to be in the fall posture. The fall posture shown in FIG. 4 and FIG. 5 is just an embodiment but the present disclosure is not limited by it. The fall posture mentioned in the present disclosure includes any fall postures.

FIG. 6 shows a block diagram of the microprocessor of the present disclosure. Please refer to FIG. 1 to FIG. 5 together. The microprocessor 102 includes a point cloud capturing unit 112, a point cloud classification unit 114, a point cloud characterization unit 118, a point cloud characteristic extracting unit 122, a characteristic comparing unit 126, a characteristic database unit 128 and a point cloud reliability checking unit 134. The units mentioned above are electrically connected to each other.

The point cloud capturing unit 112 is configured to obtain the point cloud information 110 based on the reflected radar wave 108. The point cloud reliability checking unit 134 is configured to check the point cloud information 110. If the point cloud information 110 checked by the point cloud reliability checking unit 134 is correct, the point cloud capturing unit 112 is configured to transmit the point cloud information 110 to the point cloud classification unit 114. If the point cloud information 110 checked by the point cloud reliability checking unit 134 is incorrect (for example, a temporary error caused by dust), the incorrect point cloud information 110 will be ignored/omitted. In other words, the point cloud reliability checking unit 134 has a determination mechanism (namely, a determination standard) to determine whether the point cloud information 110 is correct. If the point cloud information 110 passes the determination standard, the point cloud information 110 can be used. If the point cloud information 110 does not achieve the determination standard, the point cloud information 110 needs to be recollected/recaptured.

The point cloud classification unit 114 is configured to classify the point cloud information 110 to obtain a point cloud classification information 116. The point cloud classification unit 114 is configured to transmit the point cloud classification information 116 to the point cloud characterization unit 118. The point cloud characterization unit 118 is configured to characterize the point cloud classification information 116 to obtain a point cloud characterization information 120. The point cloud characterization unit 118 is configured to transmit the point cloud characterization information 120 to the point cloud characteristic extracting unit 122. The point cloud characteristic extracting unit 122 is configured to obtain a characteristic information 124 based on the point cloud characterization information 120.

The point cloud characteristic extracting unit 122 is configured to transmit the characteristic information 124 to the characteristic comparing unit 126. The characteristic database unit 128 is configured to transmit a fall characteristic information 130 to the characteristic comparing unit 126. The characteristic comparing unit 126 is configured to compare the characteristic information 124 with the fall characteristic information 130. If the characteristic information 124 matches the fall characteristic information 130, the characteristic comparing unit 126 is configured to determine that the human body 20 is in the fall posture. If the characteristic comparing unit 126 determines that the human body 20 is in the fall posture, the characteristic comparing unit 126 is configured to inform the warning unit 132 that the human body 20 is in the fall posture, so as to generate the warning sound (if the warning unit 132 is the loudspeaker), or to inform the wireless signal receiver (if the warning unit 132 is the wireless signal transmitter).

The point cloud capturing unit 112, the point cloud classification unit 114, the point cloud characterization unit 118, the point cloud characteristic extracting unit 122, the characteristic comparing unit 126, the characteristic database unit 128 and the point cloud reliability checking unit 134 can be integrated into the microprocessor 102. Namely, the respective works of the above-mentioned units are all performed by the microprocessor 102. Or, the above-mentioned units are respective microprocessors or signal processors or electronic components, so as to perform the respective works of the above-mentioned units.

For example, the point cloud capturing unit 112 is a first microprocessor or a first signal processor; the point cloud classification unit 114 is a second microprocessor or a second signal processor; the point cloud characterization unit 118 is a third microprocessor or a third signal processor; the point cloud characteristic extracting unit 122 is a fourth microprocessor or a fourth signal processor; the characteristic comparing unit 126 is a comparator; the characteristic database unit 128 is a memory which stores a database; the point cloud reliability checking unit 134 is a fifth microprocessor or a fifth signal processor.

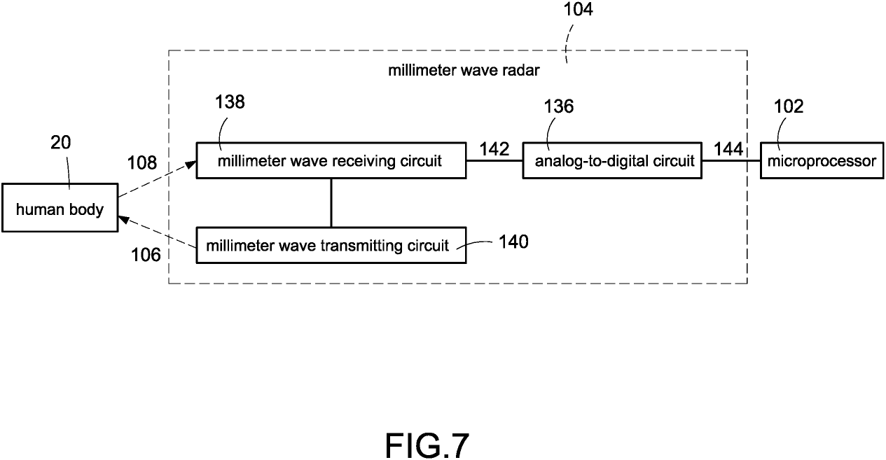

Moreover, FIG. 7 shows a block diagram of an embodiment of the millimeter wave radar of the present disclosure. Please refer to FIG. 1 to FIG. 6 together. The millimeter wave radar 104 includes an analog-to-digital circuit 136, a millimeter wave receiving circuit 138 and a millimeter wave transmitting circuit 140. The analog-to-digital circuit 136 is electrically connected to the microprocessor 102. The millimeter wave receiving circuit 138 is electrically connected to the analog-to-digital circuit 136. The millimeter wave transmitting circuit 140 is electrically connected to the millimeter wave receiving circuit 138. The millimeter wave transmitting circuit 140 is configured to transmit the radar wave 106 to the human body 20. The millimeter wave receiving circuit 138 is configured to receive the reflected radar wave 108 reflected from the human body 20 based on the radar wave 106. The millimeter wave receiving circuit 138 is configured to process the reflected radar wave 108 to obtain an analog signal 142. The millimeter wave receiving circuit 138 is configured to transmit the analog signal 142 to the analog-to-digital circuit 136. The analog-to-digital circuit 136 is configured to process the analog signal 142 to obtain a digital signal 144. The analog-to-digital circuit 136 is configured to transmit the digital signal 144 to the microprocessor 102. The digital signal 144 includes the point cloud information body 110.

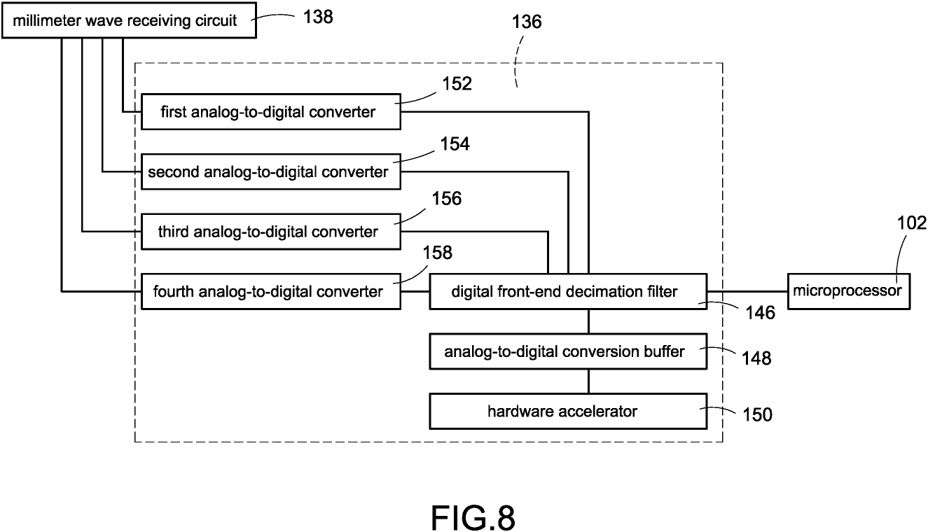

Moreover, FIG. 8 shows a block diagram of an embodiment of the analog-to-digital circuit of the present disclosure. Please refer to FIG. 1 to FIG. 7 together. The analog-to-digital circuit 136 includes a digital front-end decimation filter 146, an analog-to-digital conversion buffer 148, a hardware accelerator 150, a first analog-to-digital converter 152, a second analog-to-digital converter 154, a third analog-to-digital converter 156 and a fourth analog-to-digital converter 158. The digital front-end decimation filter 146 is electrically connected to the microprocessor 102. The analog-to-digital conversion buffer 148 is electrically connected to the digital front-end decimation filter 146. The hardware accelerator 150 is electrically connected to the analog-to-digital conversion buffer 148. The first analog-to-digital converter 152 is electrically connected to the digital front-end decimation filter 146 and the millimeter wave receiving circuit 138. The second analog-to-digital converter 154 is electrically connected to the digital front-end decimation filter 146 and the millimeter wave receiving circuit 138. The third analog-to-digital converter 156 is electrically connected to the digital front-end decimation filter 146 and the millimeter wave receiving circuit 138. The fourth analog-to-digital converter 158 is electrically connected to the digital front-end decimation filter 146 and the millimeter wave receiving circuit 138.

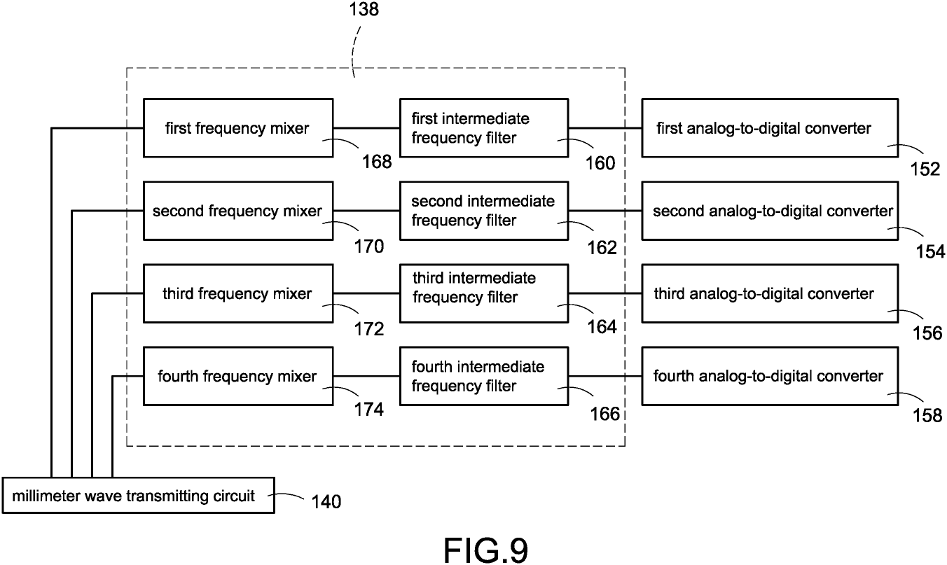

Moreover, FIG. 9 shows a partial block diagram of an embodiment of the millimeter wave receiving circuit of the present disclosure. Please refer to FIG. 1 to FIG. 8 together. The millimeter wave receiving circuit 138 includes a first intermediate frequency filter 160, a second intermediate frequency filter 162, a third intermediate frequency filter 164, a fourth intermediate frequency filter 166, a first frequency mixer 168, a second frequency mixer 170, a third frequency mixer 172 and a fourth frequency mixer 174. The first intermediate frequency filter 160 is electrically connected to the first analog-to-digital converter 152. The second intermediate frequency filter 162 is electrically connected to the second analog-to-digital converter 154. The third intermediate frequency filter 164 is electrically connected to the third analog-to-digital converter 156. The fourth intermediate frequency filter 166 is electrically connected to the fourth analog-to-digital converter 158. The first frequency mixer 168 is electrically connected to the first intermediate frequency filter 160 and the millimeter wave transmitting circuit 140. The second frequency mixer 170 is electrically connected to the second intermediate frequency filter 162 and the millimeter wave transmitting circuit 140. The third frequency mixer 172 is electrically connected to the third intermediate frequency filter 164 and the millimeter wave transmitting circuit 140. The fourth frequency mixer 174 is electrically connected to the fourth intermediate frequency filter 166 and the millimeter wave transmitting circuit 140.

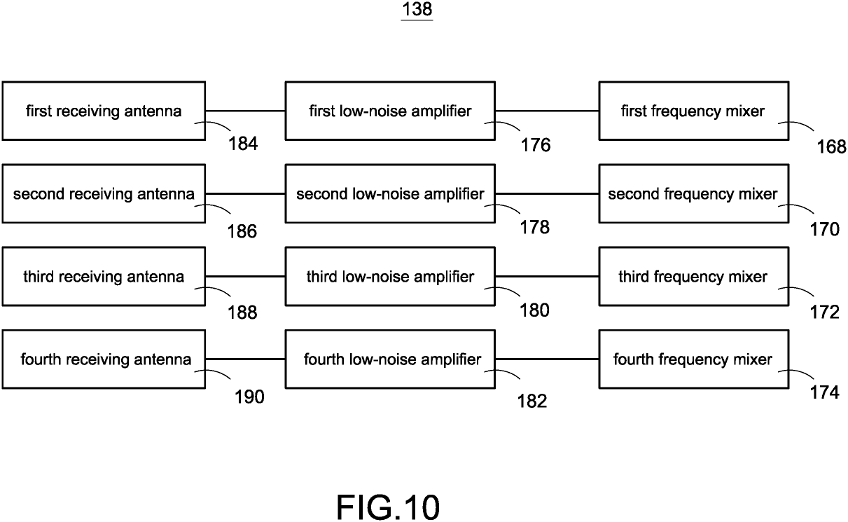

Moreover, FIG. 10 shows another partial block diagram of the embodiment of the millimeter wave receiving circuit of the present disclosure. Please refer to FIG. 1 to FIG. 9 together. The millimeter wave receiving circuit 138 further includes a first low-noise amplifier 176, a second low-noise amplifier 178, a third low-noise amplifier 180, a fourth low-noise amplifier 182, a first receiving antenna 184, a second receiving antenna 186, a third receiving antenna 188 and a fourth receiving antenna 190. The first low-noise amplifier 176 is electrically connected to the first frequency mixer 168. The second low-noise amplifier 178 is electrically connected to the second frequency mixer 170. The third low-noise amplifier 180 is electrically connected to the third frequency mixer 172. The fourth low-noise amplifier 182 is electrically connected to the fourth frequency mixer 174. The first receiving antenna 184 is electrically connected to the first low-noise amplifier 176. The second receiving antenna 186 is electrically connected to the second low-noise amplifier 178. The third receiving antenna 188 is electrically connected to the third low-noise amplifier 180. The fourth receiving antenna 190 is electrically connected to the fourth low-noise amplifier 182.

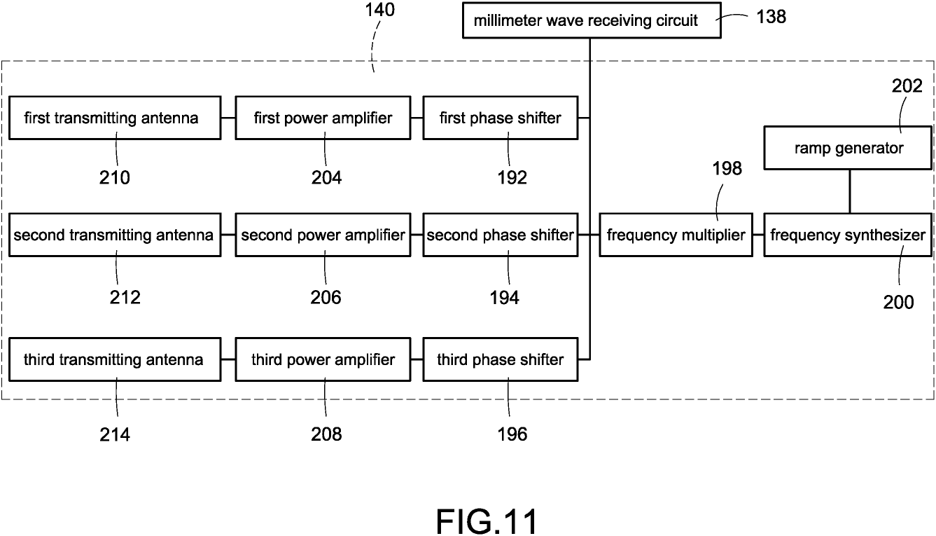

Moreover, FIG. 11 shows a block diagram of an embodiment of the millimeter wave transmitting circuit of the present disclosure. Please refer to FIG. 1 to FIG. 10 together. The millimeter wave transmitting circuit 140 includes a first phase shifter 192, a second phase shifter 194, a third phase shifter 196, a frequency multiplier 198, a frequency synthesizer 200 and a ramp generator 202. The first phase shifter 192 is electrically connected to the millimeter wave receiving circuit 138. The second phase shifter 194 is electrically connected to the millimeter wave receiving circuit 138. The third phase shifter 196 is electrically connected to the millimeter wave receiving circuit 138. The frequency multiplier 198 is electrically connected to the millimeter wave receiving circuit 138, the first phase shifter 192, the second phase shifter 194 and the third phase shifter 196. The frequency synthesizer 200 is electrically connected to the frequency multiplier 198. The ramp generator 202 is electrically connected to the frequency synthesizer 200.

Moreover, according to FIG. 11, the millimeter wave transmitting circuit 140 further includes a first power amplifier 204, a second power amplifier 206, a third power amplifier 208, a first transmitting antenna 210, a second transmitting antenna 212 and a third transmitting antenna 214. The first power amplifier 204 is electrically connected to the first phase shifter 192. The second power amplifier 206 is electrically connected to the second phase shifter 194. The third power amplifier 208 is electrically connected to the third phase shifter 196. The first transmitting antenna 210 is electrically connected to the first power amplifier 204. The second transmitting antenna 212 is electrically connected to the second power amplifier 206. The third transmitting antenna 214 is electrically connected to the third power amplifier 208.

The advantage of the present disclosure is to conveniently and accurately determine that the human body is in the fall posture, so as to further warn and provide assistance or rescue.

Although the present disclosure has been described with reference to the preferred embodiment thereof, it will be understood that the disclosure is not limited to the details thereof. Various substitutions and modifications have been suggested in the foregoing description, and others will occur to those of ordinary skill in the art. Therefore, all such substitutions and modifications are intended to be embraced within the scope of the disclosure as defined in the appended claims.

What is claimed is:

1. A millimeter wave radar apparatus determining a fall posture applied to a human body, the millimeter wave radar apparatus comprising:
a microprocessor; and
a millimeter wave radar electrically connected to the microprocessor,
wherein the millimeter wave radar is configured to transmit a radar wave to the human body; the millimeter wave radar is configured to receive a reflected radar wave reflected from the human body based on the radar wave; the microprocessor is configured to obtain a point cloud information based on the reflected radar wave; the microprocessor is configured to utilize the point cloud information to determine whether the human body is in the fall posture.

2. The millimeter wave radar apparatus of claim 1, wherein the microprocessor comprises:
a point cloud capturing unit electrically connected to the millimeter wave radar,
wherein the point cloud capturing unit is configured to obtain the point cloud information based on the reflected radar wave.

3. The millimeter wave radar apparatus of claim 2, wherein the microprocessor further comprises:
a point cloud classification unit electrically connected to the point cloud capturing unit,
wherein the point cloud capturing unit is configured to transmit the point cloud information to the point cloud classification unit; the point cloud classification unit is configured to classify the point cloud information to obtain a point cloud classification information.

4. The millimeter wave radar apparatus of claim 3, wherein the microprocessor further comprises:
a point cloud characterization unit electrically connected to the point cloud classification unit,
wherein the point cloud classification unit is configured to transmit the point cloud classification information to the point cloud characterization unit; the point cloud characterization unit is configured to characterize the point cloud classification information to obtain a point cloud characterization information.

5. The millimeter wave radar apparatus of claim 4, wherein the microprocessor further comprises:
a point cloud characteristic extracting unit electrically connected to the point cloud characterization unit,
wherein the point cloud characterization unit is configured to transmit the point cloud characterization information to the point cloud characteristic extracting unit; the point cloud characteristic extracting unit is configured to obtain a characteristic information based on the point cloud characterization information.

6. The millimeter wave radar apparatus of claim 5, wherein the microprocessor further comprises:
a characteristic comparing unit electrically connected to the point cloud characteristic extracting unit,
wherein the point cloud characteristic extracting unit is configured to transmit the characteristic information to the characteristic comparing unit.

7. The millimeter wave radar apparatus of claim 6, wherein the microprocessor further comprises:
a characteristic database unit electrically connected to the characteristic comparing unit,
wherein the characteristic database unit is configured to transmit a fall characteristic information to the characteristic comparing unit; the characteristic comparing unit is configured to compare the characteristic information with the fall characteristic information; if the characteristic information matches the fall characteristic information, the characteristic comparing unit is configured to determine that the human body is in the fall posture.

8. The millimeter wave radar apparatus of claim 7, further comprising:
a warning unit electrically connected to the characteristic comparing unit,
wherein if the characteristic comparing unit determines that the human body is in the fall posture, the characteristic comparing unit is configured to inform the warning unit that the human body is in the fall posture,
wherein the microprocessor further comprises:
a point cloud reliability checking unit electrically connected to the point cloud capturing unit,
wherein the point cloud reliability checking unit is configured to check the point cloud information; if the point cloud information checked by the point cloud reliability checking unit is correct, the point cloud capturing unit is configured to transmit the point cloud information to the point cloud classification unit.

9. The millimeter wave radar apparatus of claim 8, wherein the warning unit is an output warning apparatus.

10. The millimeter wave radar apparatus of claim 8, wherein the warning unit is configured to transmit a warning signal provided to other apparatuses to use.
